(19) United States
(12) Patent Application Publication
(10) Pub. No.: US 2005/0012979 A1
(43) Pub. Date: Jan. 20, 2005

(54) Electrophoretic Display

(76) Inventor: Masato Minami, Atsugi-shi (JP)

Correspondence Address: MORGAN & FINNEGAN, L.L.P., 3 WORLD FINANCIAL CENTER, NEW YORK, NY, 10281-2101, US

(21) Appl. No.: 10/769,374

(22) Filed: Jan. 30, 2004

(30) Foreign Application Priority Data
Jan. 31, 2003 (JP) 2003-024295

(51) Int. Cl. G02B 26/00

(52) U.S. Cl. 359/296

(57) ABSTRACT

An electrophoretic display is constituted by a substrate, a first electrode and a second electrode disposed on the substrate, and microcapsules each, disposed on the substrate, containing a dispersion liquid comprising a dispersion medium and two species of electrophoretic particles different in charge polarity and color. The first and second electrodes are disposed so as to create an electric field along a surface of the substrate and are to be supplied with a voltage so as to move the two species of electrophoretic particles in mutually opposite directions along the electric field to effect white/black display or color display is combination with a color filter.

### FIELD OF THE INVENTION AND RELATED ART

The present invention relates to an electrophoretic display using the electrophoretic particles.

In recent years, with development of information equipment, the needs for low-power and thin display apparatuses have grown, so that extensive study and development have been made on display apparatuses fitted to these needs. Of these display apparatuses, a liquid crystal display apparatus has been developed actively as a display apparatus capable of meeting the needs by electrically controlling alignment of liquid crystal molecules to change optical characteristic of the liquid crystal and has been brought into the commercial stage.

However, the liquid crystal display apparatus is accompanied with such problems that it has poor viewability of characters on a picture area due to a viewing angle or reflection light and that an eyestrain problem caused by flickering, low luminance, etc., of a light source is not sufficiently solved. For this reason, a display apparatus with less eyestrain has been extensively studied.

As one of such display apparatus, an electrophoretic display has been proposed by Harold D. Lees et al. (e.g., U.S. Pat. No. 3,612,758).

FIG. 13 shows an embodiment of a sectional structure and an operational principle of a conventional electrophoretic display. Referring to FIG. 13, the electrophoretic display includes a pair of substrates 5a and 5b oppositely disposed with a predetermined spacing, and electrodes 5c and 5d disposed on the substrates 5a and 5b, respectively. At the spacing between the substrates 5a and 5b, a large number of electrophoretic particles 5e which have been positively charged and colored, and a dispersion medium 5f which has been colored a color different from that of the electrophoretic particles 5e are disposed and filled. Further, a partition wall 5g is disposed so that it divides the spacing into a large number of pixels along a surface of the substrates, thus preventing localization of the electrophoretic particles 5e and defining the spacing between the substrates.

In such an electrophoretic display, when the lower electrode 5c is supplied with a negative-polarity voltage and the upper electrode 5d is supplied with a positive-polarity voltage as shown in FIG. 13A, the positively charged electrophoretic particles 5e get together so as to cover the lower electrode 5c. When this electrophoretic display is viewed from a direction of an indicated arrow C, display of the same color as the dispersion medium is effected. On the other hand, when the lower electrode 5c is supplied with the positive-polarity voltage and the upper electrode 5d is supplied with the negative-polarity voltage as shown in FIG. 13B, the electrophoretic particles 5e get together so as to cover the upper electrode 5d. When this electrophoretic display is viewed from the indicated arrow A direction, display of the same color as the electrophoretic particles 5e is effected. Such a driving of the electrophoretic display is effected on a pixel-by-pixel basis, whereby arbitrary images are displayed at the large number of pixels.

In such a conventional electrophoretic display, there have arisen problems such that the electrophoretic particles get over the partition wall to be moved to adjacent pixels and that the dispersion liquid leaks out of the electrophoretic display.

### SUMMARY OF THE INVENTION

An object of the present invention is to provide an electrophoretic display having solved the above mentioned problems, i.e., movement of electrophoretic particles to adjacent pixels and leakage of the dispersion liquid out of the electrophoretic display.

Another object of the present invention is to provide a process for producing the electrophoretic display.

According to the present invention, there is provided an electrophoretic display, comprising: a substrate, a first electrode and a second electrode disposed on the substrate, and microcapsules each, disposed on the substrate, containing a dispersion liquid comprising a dispersion medium and two species of electrophoretic particles different in charge polarity and color,
wherein the first and second electrodes are disposed so as to create an electric field along a surface of the substrate and are to be supplied with a voltage so as to move the two species of electrophoretic particles in mutually opposite directions along the electric field to effect display.

In the case of white/black display, the electrophoretic display includes two species of electrophoretic particles consisting of white electrophoretic particles and black electrophoretic particles.

Further, in the case of color display, the electrophoretic display further includes a color filter disposed on the microcapsules.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1(A) and 1(B) are a sectional view and a top view, respectively, showing an embodiment of the electrophoretic display according to the present invention.

FIGS. 2(A), 2(A′), 2(B) and 2(B′) are schematic views showing a display embodiment of the electrophoretic display using microcapsules according to the present invention.

FIGS. 3(A) to 3(C) are schematic views for illustrating an embodiment of a process for producing the electrophoretic display of the present invention.

FIGS. 4(A) and 4(B) are a sectional view and a top view, respectively, showing another embodiment of the electrophoretic display of the present invention.

FIGS. 5(A), 5(A′), 5(B) and 5(B′) are schematic views showing another display embodiment of the electrophoretic display using microcapsules according to the present invention.

FIGS. 6-1(A) to 6-2(D) are schematic views for illustrating another embodiment of a process for producing the electrophoretic display of the present invention.

FIGS. 7(A) and 7(B) are a sectional view and a top view, respectively, showing another embodiment of the electrophoretic display of the present invention.

FIGS. 8(A), 8(A′), 8(B) and 8(B′) are schematic views showing another display embodiment of the electrophoretic display using microcapsules according to the present invention.

FIGS. 9(A) to 9(C) are schematic views for illustrating another embodiment of a process for producing the electrophoretic display of the present invention.

FIGS. 10(A) and 10(B) are a sectional view and a top view, respectively, showing another embodiment of the electrophoretic display of the present invention.

FIGS. 11(A), 11(A′), 11(B) and 11(B′) are schematic views showing another display embodiment of the electrophoretic display using microcapsules according to the present invention.

FIGS. 12-1(A) to 12-2(D) are schematic views for illustrating another embodiment of a process for producing the electrophoretic display of the present invention.

FIGS. 13(A) and 13(B) are schematic views of a conventional electrophoretic display.

### DETAILED DESCRIPTION OF THE PREFERRED EMBODIMENTS

Hereinbelow, embodiments of the electrophoretic display according to the present invention will be described with reference to the drawings.

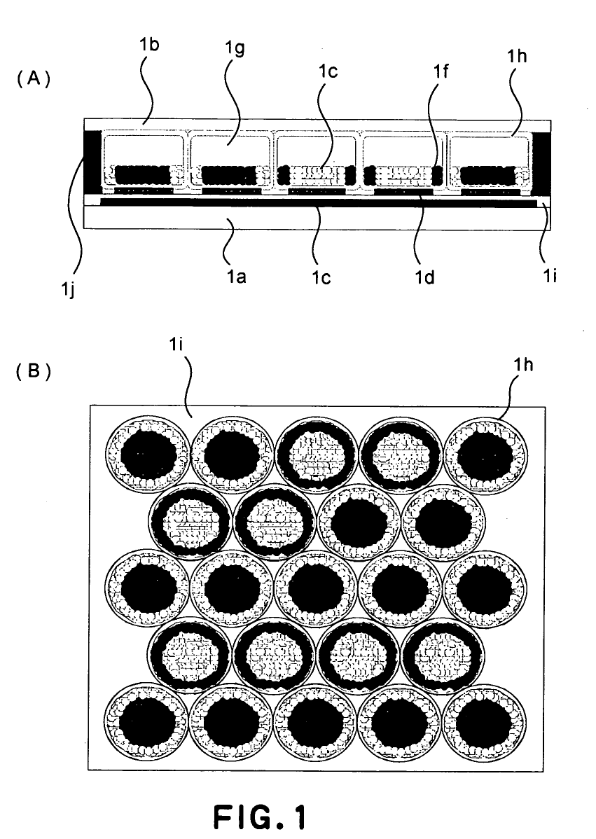

FIG. 1 shows an embodiment of the electrophoretic display of the present invention, wherein FIG. 1(A) is a sectional view and FIG. 1(B) is a top view schematically illustrating an arrangement of microcapsules.

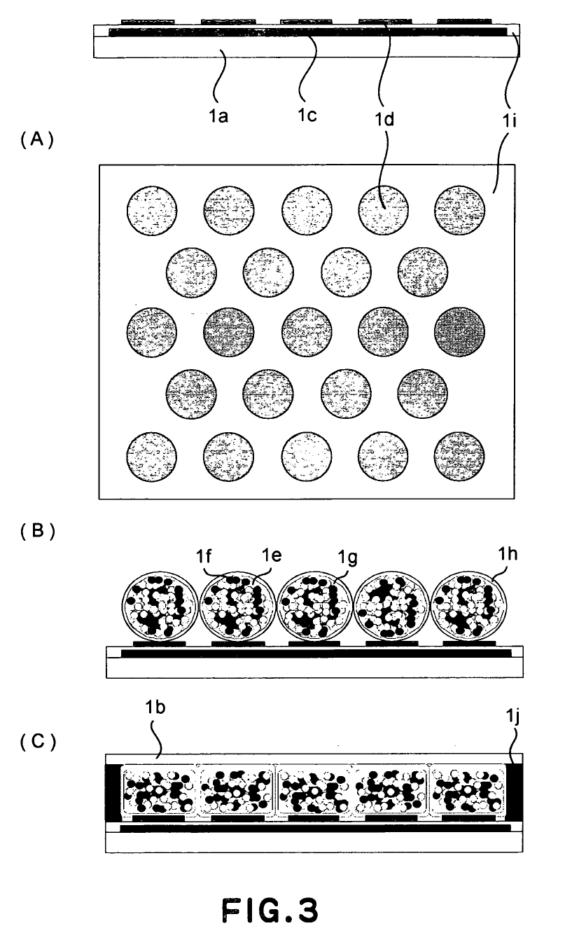

Referring to FIG. 1(A), the electrophoretic display includes a pair of first and second substrates 1a and 1b. On the first substrate 1a, a first electrode 1c and a second electrode 1d are formed. On the second electrode 1d, a microcapsule 1h is disposed so as to be sandwiched between the first and second substrate 1a and 1b. The second electrode 1d has a circular shape having a predetermined size, and a plurality of circular second electrodes 1d are arranged in a honeycomb shape as shown in FIG. 3(A). Between the first and second substrates 1c and 1d, an insulating layer 1i is formed. The first and second substrates 1a and 1b are sealed with an adhesive 1j. Each of a plurality of microcapsules 1h has a shape such that a horizontal length thereof is longer than a vertical length thereof with respect to the first substrate 1a. Each microcapsule 1h contains a dispersion liquid comprising a dispersion medium 1g and two species of electrophoretic particles 1e and 1f different in color and polarity. The electrophoretic display has a display surface on the second substrate 1b side. The microcapsules 1h are two-dimensionally arranged as shown in FIG. 1(B) and disposed on associated second electrodes 1d, respectively. In FIG. 1(B), the second substrate 1b is not shown.

In FIG. 1, the second electrodes 1d are pixel electrodes each capable of independently applying a desired electric field to an associated microcapsule 1h. Each pixel electrode is provided with a switching device. To the pixel electrodes, a selection signal is applied from an unshown matrix drive circuit for each row line. Further, to the pixel electrodes, a control signal and an output from a drive transistor are applied. As a result, it becomes possible to apply a desired electric field to individual microcapsules 1h, respectively.

The two species of electrophoretic particles 1e and 1f in each microcapsule 1h are controlled by the electric field applied to the second electrode 1d, whereby white/black display is effected at each pixel. The first electrode 1c is a common electrode for applying a voltage at an identical potential over the entire display area.

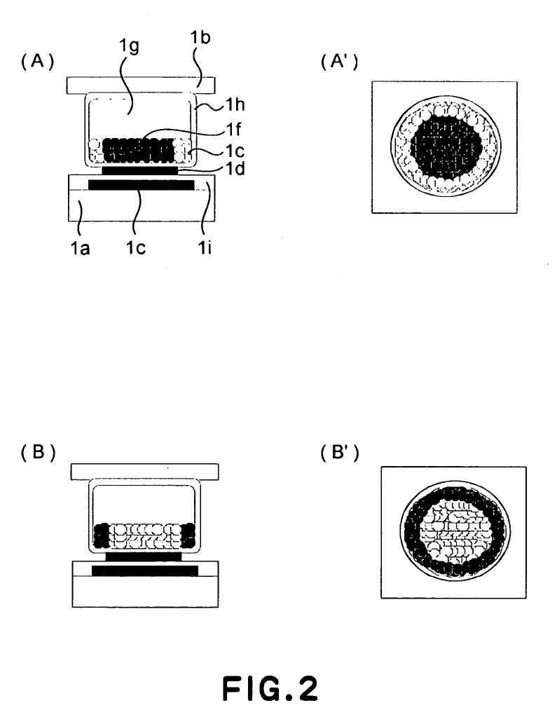

Next, a display operation of the electrophoretic display of the present invention will be described with reference to FIG. 2, wherein FIGS. 2(A) and 2(B) are sectional views of the electrophoretic display and FIGS. 2(A′) and 2(B′) are top views.

As described above, each microcapsule 1h contains therein the electrophoretic particles 1e and if different in color and polarity and the dispersion medium 1g. The electrophoretic particles 1e are positively charged white particles, and the electrophoretic particles 1f are negatively charged black particles. The dispersion medium 1g an insulating solvent which is colorless and transparent.

When 0 V is applied to the first electrode 1c and a positive (+) voltage is applied to the second electrode 1d, the electrophoretic particles 1e gather on the first electrode 1c and the electrophoretic particles 1f gather on the second electrode 1d. As a result, when the electrophoretic display is viewed from above, the microcapsules 1h look black (FIGS. 2(A) and 2(A′)). On the other hand, when 0 V is applied to the first electrode 1c and a negative (−) voltage is applied to the second electrode 1d, the electrophoretic particles 1e gather on the second electrode 1d and the electrophoretic particles 1f gather on the first electrode 1c. As a result, when the electrophoretic display is viewed from above, the microcapsules 1h look white (FIGS. 2(B) and 2(B′)). By doing so, it is possible to effect white/black display.

Next, a production process of the electrophoretic display of the present invention will be described with reference to FIG. 3, wherein FIGS. 3(A), 3(B) and 3(C) are process views showing a process for producing the electrophoretic display.

Referring to FIG. 3(A), on the first substrate 1a, the first electrode 1c is formed as the common electrode and thereon, the insulating layer 1i is formed. On the insulating layer 1i, a plurality of second electrodes 1d for controlling the dispersion liquid are patterned in a honeycomb shape consisting of circles each having a predetermined diameter.

The first substrate 1a is an arbitrary insulating member for supporting the electrophoretic display and is formed of glass, plastics, etc.

A material for the first electrode 1c is not particularly limited but may preferably be ITO (indium tin oxide), aluminum, titanium, an organic conductive film, etc.

The insulating layer 1i is also not particularly restricted so long as it is formed of an insulating resin, such as acrylic resin, epoxy resin, fluorine-containing resin, silicone resin, polyimide resin, polystyrene resin or polyalkene resin.

Patterning of the second electrodes 1d is performed through a photolithographic process with, e.g., Al or ITO. The circular second electrode 1d has a diameter which is 50-95%, preferably 60-90%, of that of the associated microcapsule 1h. If the diameter of the second electrode 1d is less than 50% or above 95% of the microcapsule 1h diameter, a resultant display contrast is undesirably lowered.

On the second electrodes 1d disposed on the first substrate 1a, a plurality of microcapsules 1h each containing the dispersion liquid comprising the electrophoretic particles 1e and 1f and the dispersion medium 1g are disposed (FIG. 3(B)).

A method of arranging the microcapsules 1h is not particularly limited but may preferably be an ink jet method using nozzles or an electrostatic transfer method.

The microcapsules 1h may be prepared by a known method such as interfacial polymerization, in situ polymerization or coacervation method, and classified into those having an objective particle size by classifying operation. The diameter of the microcapsules 1h may be 10-50 μm, preferably 20-200 μm.

If the diameter of the microcapsules 1h is smaller than 10 μm, a resultant display contrast is undesirably lowered. On the other hand, if the diameter is larger than 500 μm, a film strength of microcapsule 1h is lowered, thus being not practical. A material for forming the microcapsules 1h may preferably be a material which is fully light transmissive. Examples of the material may include urea-formaldehyde resin, melamine-formaldehyde resin, polyester, polyurethane, polyamide, polyethylene, polystyrene, polyvinyl alcohol, gelatin, and copolymers thereof.

As the electrophoretic particles 1e and 1f, it is possible to use organic pigment particles or inorganic pigment particles which are movable under application of an electric field in the dispersion medium 1g. Examples of the electrophoretic particles 1e may include white particles of titanium oxide, aluminum oxide, zinc oxide, lead oxide, tin oxide, etc. On the other hand, examples of the electrophoretic particles 1f may include black particles of carbon black, diamond black, aniline black, manganese ferrite black, cobalt ferrite black, titanium black, etc.

Further, it is possible to prepare the electrophoretic particles 1e and 1f by coating the surface of particles with a known charge control resin (CCR). The electrophoretic particles 1e and 1f may preferably have a particle size of 0.05-10 μm, more preferably 0.1-6 μm. A concentration of the electrophoretic particles 1e and 1f may preferably be 1-30 wt. %.

As the dispersion medium 1g, it is possible to use a liquid, which is high insulative and colorless and transparent, including: aromatic hydrocarbons, such as toluene, xylene, ethylbenzene and dodecylbenzene; aliphatic hydrocarbons, such as hexane, cyclohexane, kerosine, normal paraffin and isoparaffin; halogenated hydrocarbons, such as chloroform, dichloromethane, pentachloromethane, 1,2-dibromoethane, 1,1,2,2-tetrabromoethane, trichloroethylene, tetrachloroethylene, trifluoroethylene and tetrafluoroethylene, various natural or synthetic oils, etc. These may be used singly or in mixture of two or more species.

To the dispersion liquid 1g, it is possible to add a charge control agent, a dispersing agent, a lubricant, a stabilizing agent, etc., as desired.

In order to prevent positional deviation of the microcapsules 1h arranged on the first substrate 1a, a light-transmissive resin binder may be filled between the microcapsules 1h to be fixed on the first substrate 1a. Examples of the resin binder may include a water-soluble polymer, such as polyvinyl alcohol, polyurethane, polyester, acrylic resin or silicone resin.

After the microcapsules 1h containing the dispersion liquid comprising the dispersion medium 1g and the electrophoretic particles 1e and 1f are arranged on the second electrode 1d, the second substrate 1b is bonded to the first substrate 1a with an adhesive 1j so as to cover and seal the microcapsules 1h (FIG. 3(C)).

In the case of sealing the first and second substrates 1a and 1b with the adhesive 1j, it is preferable that the substrates are sealed under pressure so that a horizontal length of each microcapsule 1h is longer than a vertical length thereof with respect to the first substrate 1a.

As a material for the second substrate 1b, it is possible to use the same material as the first substrate 1a. A material for the adhesive 1j is not particularly limited so long as it provides an adhesive effect for a long period of time but may preferable be resins, such as epoxy resins, acrylic resins, polyurethane resins, vinyl acetate resins, phenolic resins, polyester resins, polybutadiene resins, and silicone resins. These resins may be used singly or in combination of two or more species.

Next, another embodiment of the electrophoretic display of the present invention will be described.

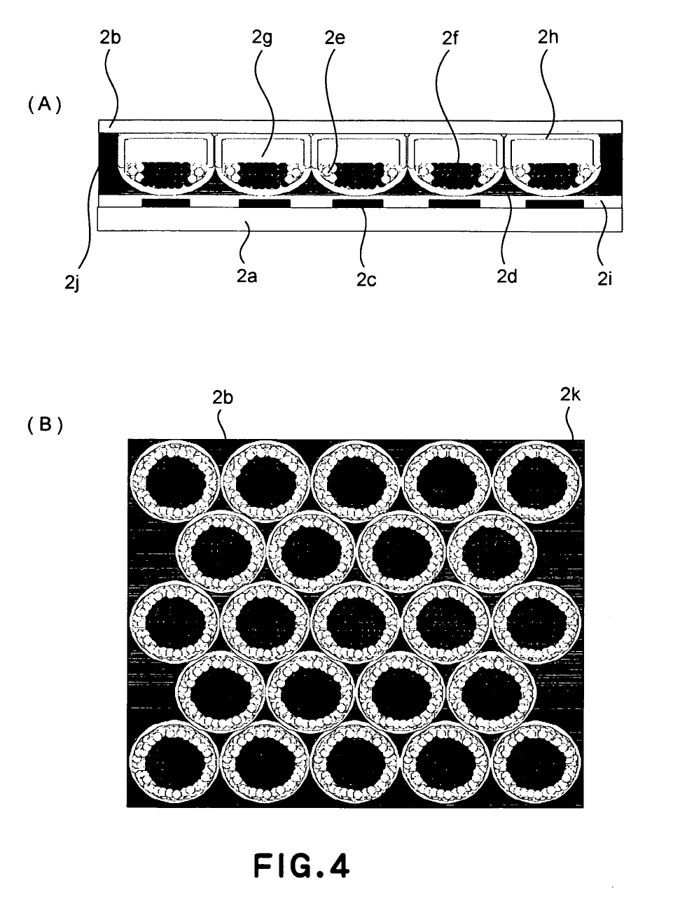

FIG. 4(A) is a sectional view showing a structure of another embodiment of the electrophoretic display of the present invention and FIG. 4(B) is a top view thereof.

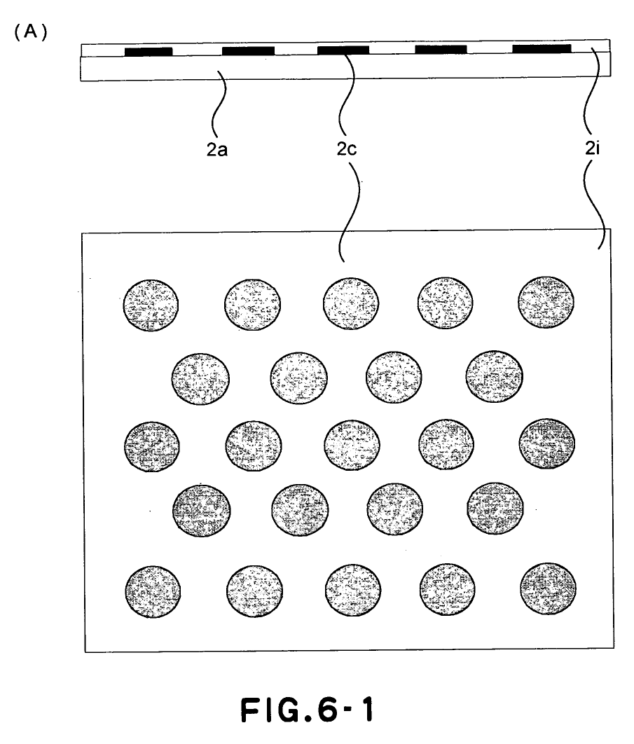

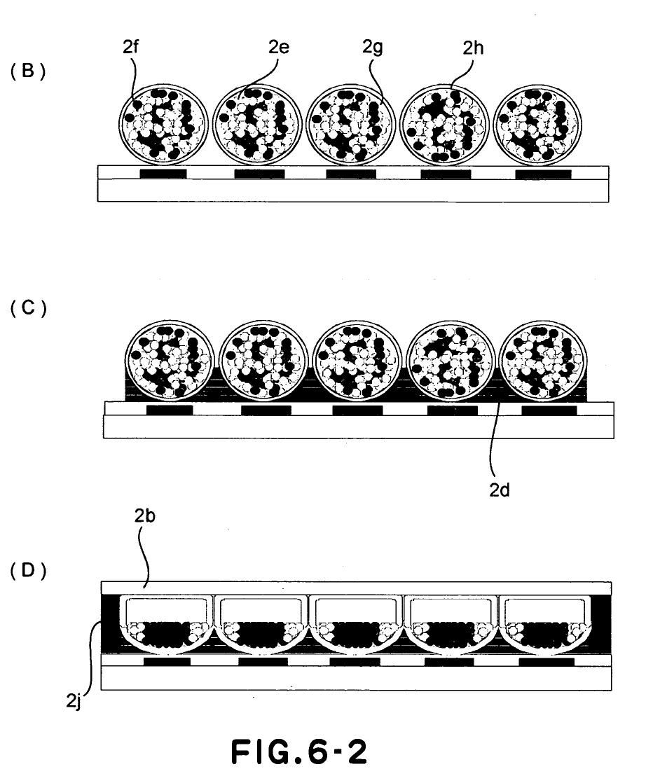

Referring to FIG. 4(A), the electrophoretic display includes a pair of first and second substrates 2a and 2b. On the first substrate 2a, a first electrode 2c and an insulating layer 2i are formed. On the first electrode 2c, a microcapsule 2h is disposed so as to be sandwiched between the first and second substrate 2a and 2b. The first and second substrates 2a and 2b are sealed with an adhesive 2j. At a spacing between the insulating layer 2i and the microcapsule 2h, a second electrode 2d is formed. The first electrode 2c has a circular shape having a predetermined size, and a plurality of circular first electrodes 2c are arranged in a honeycomb shape as shown in FIG. 6-1(A). Each of a plurality of microcapsules 2h has a shape such that a horizontal length thereof is longer than a vertical length thereof with respect to the first substrate 2a. Each microcapsule 2h contains a dispersion liquid comprising a dispersion medium 2g and two species of electrophoretic particles 2e and 2f different in color and polarity. The electrophoretic display has a display surface on the second substrate 2b side. The microcapsules 2h are two-dimensionally arranged as shown in FIG. 4(B) and disposed on associated first electrodes 2d, respectively. In FIG. 4(B), the second substrate 2b is not shown.

In FIG. 4, the first electrodes 2c are pixel electrodes each capable of independently applying a desired electric field to an associated microcapsule 2h. Each pixel electrode is provided with a switching device. To the pixel electrodes, a selection signal is applied from an unshown matrix drive circuit for each row line. Further, to the pixel electrodes, a control signal and an output from a drive transistor are applied. As a result, it becomes possible to apply a desired electric field to individual microcapsules 2h, respectively.

The two species of electrophoretic particles 2e and 2f in each microcapsule 2h are controlled by the electric field applied to the first electrode 2c, whereby white/black display is effected at each pixel. The second electrode 2d is a common electrode for applying a voltage at an identical potential over the entire display area.

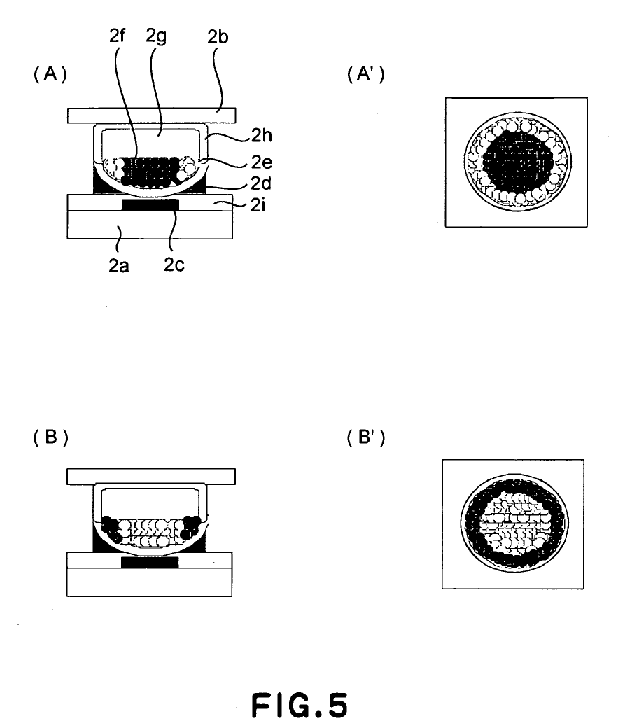

Next, a display operation of the electrophoretic display of the present invention will be described with reference to FIG. 5, wherein FIGS. 5(A) and 5(B) are sectional views of the electrophoretic display and FIGS. 5(A′) and 5(B′) are top views.

As described above, each microcapsule 2h contains therein the electrophoretic particles 2e and 2f different in color and polarity and the dispersion medium 2g. The electrophoretic particles 2e are positively charged white particles, and the electrophoretic particles 2f are negatively charged black particles. The dispersion medium 2g an insulating solvent which is colorless and transparent.

When 0 V is applied to the second electrode 2d and a positive (+) voltage is applied to the first electrode 2c, the electrophoretic particles 2e gather on the second electrode 2d and the electrophoretic particles 2f gather on the first electrode 2c. As a result, when the electrophoretic display is viewed from above, the microcapsules 2h look black (FIGS. 5(A) and 5(A′)). On the other hand, when 0 V is applied to the second electrode 2d and a negative (−) voltage is applied to the first electrode 2c, the electrophoretic particles 2e gather on the first electrode 2c and the electrophoretic particles 2f gather on the second electrode 2d. As a result, when the electrophoretic display is viewed from above, the microcapsules 2h look white (FIGS. 5(B) and 5(B′)). By doing so, it is possible to effect white/black display.

Next, a production process of the electrophoretic display of the present invention will be described with reference to FIG. 6-1 and 6-2, wherein FIGS. 6-1(A), 6-2(B) 6-2(C) and 6-2(D) are process views showing a process for producing the electrophoretic display.

Referring to FIG. 6-1(A), on the first substrate 2a, a plurality of first electrodes 2c for controlling the dispersion liquid are patterned in a honeycomb shape consisting of circles each having a predetermined diameter, and thereon, the insulating layer 2i is formed.

The first substrate 2a is an arbitrary insulating member for supporting the electrophoretic display and is formed of glass, plastics, etc.

Patterning of the first electrodes 2c is performed through a photolithographic process with, e.g., Al or ITO. The circular first electrode 2c has a diameter which is 50-95%, preferably 60-90%, of that of the associated microcapsule 2h. If the diameter of the first electrode 2c is less than 50% or above 95% of the microcapsule 2h diameter, a resultant display contrast is undesirably lowered.

The insulating layer 2i is not limited particularly so long as it is insoluble, in a solvent which dissolves an electroconductive polymer described later but may preferably be polyimide.

On the first electrodes 2c disposed on the first substrate 2a, a plurality of microcapsules 2h each containing the dispersion liquid comprising the electrophoretic particles 2e and 2f and the dispersion medium 2g are disposed (FIG. 6-2(B)).

A method of arranging the microcapsules 2h is not particularly limited but may preferably be an ink jet method using nozzles or an electrostatic transfer method.

The microcapsules 2h may be prepared by the above described known method such as interfacial polymerization, in situ polymerization or coacervation method. The diameter of the microcapsules 2h may be 10-50 μm, preferably 20-200 μm.

If the diameter of the microcapsules 2h is smaller than 10 μm, a resultant display contrast is undesirably lowered. On the other hand, if the diameter is larger than 500 μm, a film strength of microcapsule 2h is lowered, thus being not practical. A material for forming the microcapsules 2h is the same as the microcapsules 1h described above.

Similarly, materials of the electrophoretic particles 2e and 2f and the dispersion medium 2g are the same as the electrophoretic particles 1e and 1f and the dispersion medium 1g, respectively.

To the dispersion liquid 2g, it is possible to add a charge control agent, a dispersing agent, a lubricant, a stabilizing agent, etc., as desired.

After the microcapsules 2h containing the dispersion liquid comprising the electrophoretic particles 2e and 2f and the dispersion medium 2g is arranged on the first electrodes 2c, the second electrode 2d is formed at a spacing between the insulating layer 2i and the microcapsules 2h (FIG. 6-2(C)).

The second electrode 2d may, e.g., be formed by infiltrating a solution of an electroconductive polymer dissolved in a solvent into the spacing between the insulating layer 2i and the microcapsules 2h, and then drying and removing the solvent. Examples of the electroconductive polymer may include: heterocyclic conductive polymers, such as polythiophene and polypyrrole; polyphenylene conductive polymers, such as polyparaphenylene, polyphenylenevinylene, and polyphenylene sulfide; polyacetylene conductive polymers; polyaniline conductive polymers, sulfone group-containing conductive polymers, such as poly(2-acryloxyethyl-dimethylsulfonium chloride) and poly(glycidyl-dimethylsulfonium chloride); and quaternary ammonium salt-containing conductive polymers, such as poly(vinyltrimethylammonium chloride) and poly(N-methylvinylpyridium chloride). The electroconductive polymer may be doped with electron donor or electron acceptor, as desired. The solvent is not particularly limited so long as it dissolves the electroconductive polymer but does not dissolve the microcapsules 2h, but may preferably be halogenated solvents such as chloroform or aromatic solvents such as toluene.

After the second electrode 2d is formed at the spacing between the insulating layer 2i and the microcapsules 2h, the second substrate 2b is bonded to the first substrate 2a with an adhesive 2j so as to cover and seal the microcapsules 2h (FIG. 6-2(D)).

In the case of sealing the first and second substrates 2a and 2b with the adhesive 2j, it is preferable that the substrates are sealed under pressure so that a horizontal length of each microcapsule 2h is longer than a vertical length thereof with respect to the first substrate 2a.

As a material for the second substrate 2b, it is possible to use the same material as the first substrate 2a. A material for the adhesive 2j is also the same as the adhesive 1j.

Next, another embodiment of the electrophoretic display of the present invention will be described.

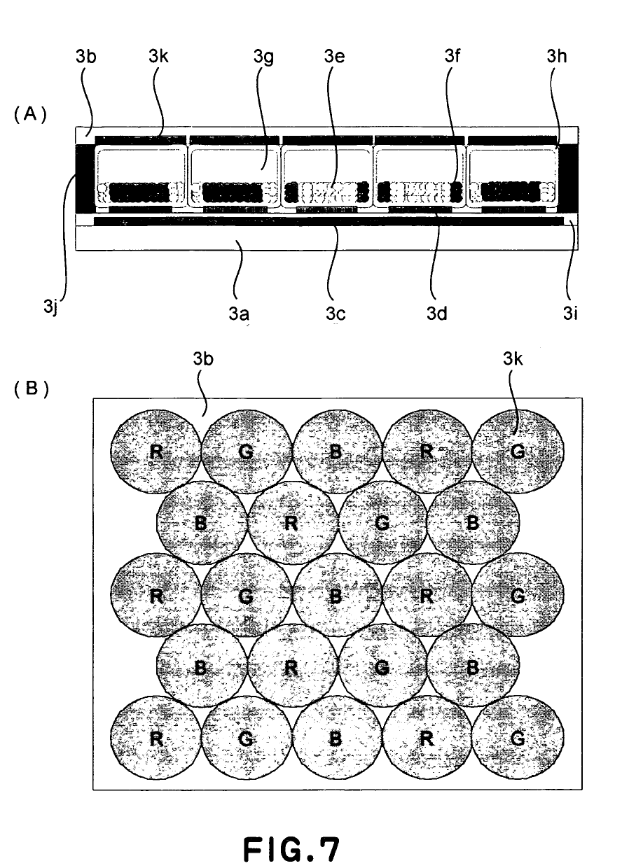

FIG. 7(A) is a sectional view showing a structure of another embodiment of the electrophoretic display of the present invention and FIG. 7(B) is a top view thereof.

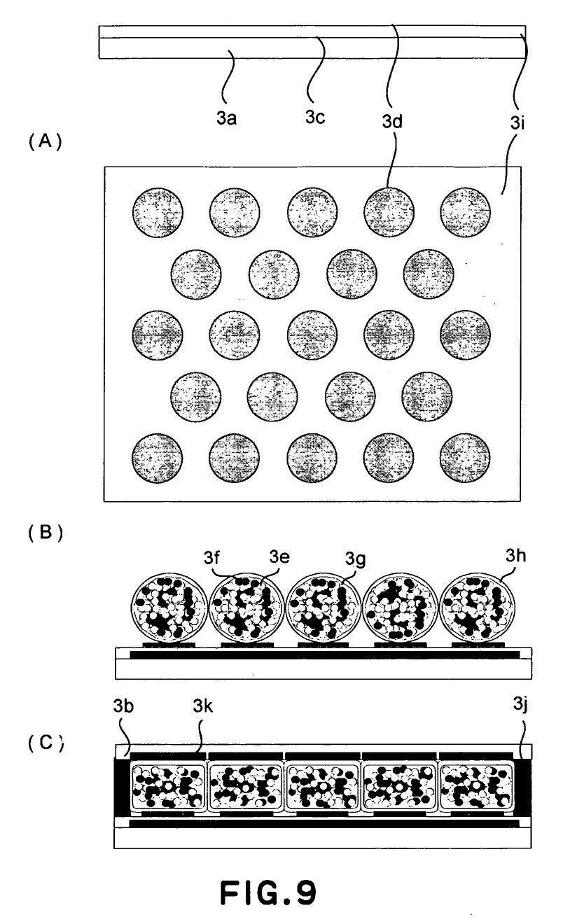

Referring to FIG. 7(A), the electrophoretic display includes a pair of first and second substrates 3a and 3b. On the first substrate 3a, a first electrode 3c and a second electrode 3d are formed. On the second electrode 3d, a microcapsule 3h is disposed so as to be sandwiched between the first and second substrate 3a and 3b. The second electrode 3d has a circular shape having a predetermined size, and a plurality of circular second electrodes 3d are arranged in a honeycomb shape as shown in FIG. 9(A). Between the first and second substrates 3c and 3d, an insulating layer 3i is formed. The first and second substrates 3a and 3b are sealed with an adhesive 3j. Each of a plurality of microcapsules 3h has a shape such that a horizontal length thereof is longer than a vertical length thereof with respect to the first substrate 3a. Each microcapsule 3h contains a dispersion liquid comprising a dispersion medium 3g and two species of electrophoretic particles 3e and 3f different in color and polarity. The electro-phoretic display has a display surface on the second substrate 3b side. Color filters 3k are two-dimensionally arranged as shown in FIG. 7(B) and disposed on the second substrate 3b, so as to be one-to-one correspondence with associated microcapsules 3h, respectively.

In FIG. 7, the second electrodes 3d are pixel electrodes each capable of independently applying a desired electric field to an associated microcapsule 3h. Each pixel electrode is provided with a switching device. To the pixel electrodes, a selection signal is applied from an unshown matrix drive circuit for each row line. Further, to the pixel electrodes, a control signal and an output from a drive transistor are applied. As a result, it becomes possible to apply a desired electric field to individual microcapsules 3h, respectively.

The two species of electrophoretic particles 3e and 3f in each microcapsule 3h are controlled by the electric field applied to the second electrode 3d, whereby white/black display is effected at each pixel. The first electrode 3c is a common electrode for applying a voltage at an identical potential over the entire display area.

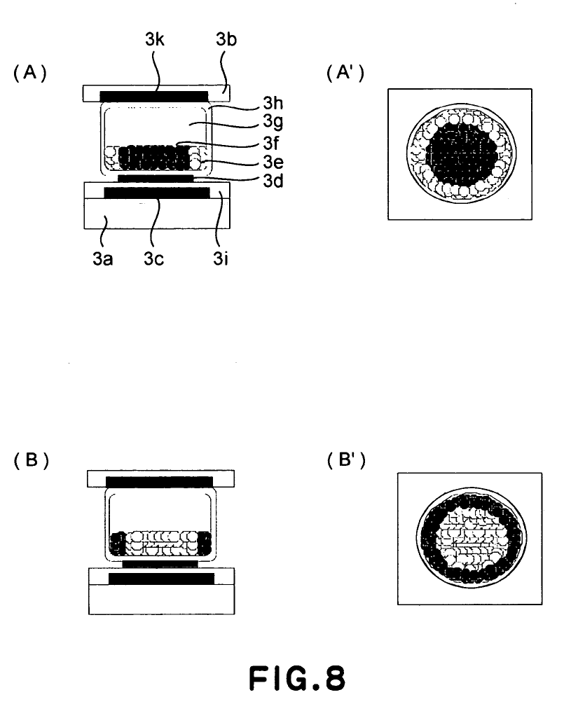

Next, a display operation of the electrophoretic display of the present invention will be described with reference to FIG. 8, wherein FIGS. 8(A) and 8(B) are sectional views of the electrophoretic display and FIGS. 8(A′) and 8(B′) are top views wherein the second substrate 3b provided with the color filters 3k is omitted.

As described above, each microcapsule 3h contains therein the electrophoretic particles 3e and 3f different in color and polarity and the dispersion medium 3g. The electrophoretic particles 3e are positively charged white particles, and the electrophoretic particles 3f are negatively charged black particles. The dispersion medium 3g an insulating solvent which is colorless and transparent. In these figures, the color filter 3k is red (R).

When 0 V is applied to the first electrode 3c and a positive (+) voltage is applied to the second electrode 3d, the electrophoretic particles 3e gather on the first electrode 3c and the electrophoretic particles 3f gather on the second electrode 3d. As a result, when the electrophoretic display is viewed from above, the microcapsules 3h look black (FIGS. 8(A) and 8(A′)). On the other hand, when 0 V is applied to the first electrode 3c and a negative (−) voltage is applied to the second electrode 3d, the electrophoretic particles 3e gather on the second electrode 3d and the electrophoretic particles 3f gather on the first electrode 3c. As a result, when the electrophoretic display is viewed from above, the microcapsules 3h look red (FIGS. 8(B) and 8(B′)).

In the case where the color filters 3k are green (G) or blue (B), it is possible to effect two-valued display of black/green or black/blue, respectively. Further, in the case where the color filters 3k are arranged on the second substrate 3b as shown in FIG. 7(B), it is possible to effect color display on the basis of electrophoresis of the electrophoretic particles 3e and 3f. In this embodiment, the color filters 3k employs primary colors of R, G and B but may also employ primary colors of yellow (Y), magenta (M), and cyan (C).

Next, a production process of the electrophoretic display of the present invention will be described with reference to FIG. 9, wherein FIGS. 9(A), 9(B) and 9(C) are process views showing a process for producing the electrophoretic display.

Referring to FIG. 9(A), on the first substrate 3a, the first electrode 3c is formed as the common electrode and thereon, the insulating layer 3i is formed. On the insulating layer 3i, a plurality of second electrodes 3d for controlling the dispersion liquid are patterned in a honeycomb shape consisting of circles each having a predetermined diameter.

The first substrate 3a is an arbitrary insulating member for supporting the electrophoretic display and is formed of glass, plastics, etc., as described above.

A material for the first electrode 3c is not particularly limited but may preferably be ITO, aluminum, titanium, an organic conductive film, etc., as described above.

The insulating layer 3i is also not particularly restricted so long as it is formed of an insulating resin, such as acrylic resin, epoxy resin, fluorine-containing resin, silicone resin, polyimide resin, polystyrene resin or polyalkene resin, as described above.

Patterning of the second electrodes 3d is performed through a photolithographic process with, e.g., Al or ITO. The circular second electrode 3d has a diameter which is 50-95%, preferably 60-90%, of that of the associated microcapsule 3h. If the diameter of the second electrode 3d is less than 50% or above 95% of the microcapsule 3h diameter, a resultant display contrast is undesirably lowered.

On the second electrodes 3d disposed on the first substrate 3a, a plurality of microcapsules 3h each containing the dispersion liquid comprising the electrophoretic particles 3e and 3f and the dispersion medium 3g are disposed (FIG. 9(B)).

A method of arranging the microcapsules 3h is not particularly limited but may preferably be an ink jet method using nozzles or an electrostatic transfer method.

The microcapsules 3h may be prepared by the above-described known method such as interfacial polymerization, in situ polymerization or coacervation method. The diameter of the microcapsules 3h may be 10-50 μm, preferably 20-200 μm.

If the diameter of the microcapsules 3h is smaller than 10 μm, a resultant display contrast is undesirably lowered. On the other hand, if the diameter is larger than 500 μm, a film strength of microcapsule 3h is lowered, thus being not practical. A material for forming the microcapsules 3h may preferably be the same polymer materials at the microcapsules 1h described above.

As the electrophoretic particles 3e and 3f and the dispersion medium 3g, it is possible to use the above-described pigment particles and the above-described dispersion mediums, respectively.

To the dispersion liquid 3g, it is possible to add a charge control agent, a dispersing agent, a lubricant, a stabilizing agent, etc., as desired.

In order to prevent positional deviation of the microcapsules 3h arranged on the first substrate 3a, a light-transmissive resin binder may be filled between the microcapsules 3h to be fixed on the first substrate 3a. Examples of the resin binder may include the above-described water-soluble polymers.

After the microcapsules 3h containing the dispersion liquid comprising the dispersion medium 3g and the electrophoretic particles 3e and 3f are arranged on the second electrode 3d, the second substrate 3b is bonded to the first substrate 3a with an adhesive 3j so as to cover and seal the microcapsules 3h (FIG. 9(C)).

In the case of sealing the first and second substrates 3a and 3b with the adhesive 3j, it is preferable that a one-to-one correspondence is created between the color filters 3k and the microcapsules 3h and that the substrates are sealed under pressure so that a horizontal length of each microcapsule 3h is longer than a vertical length thereof with respect to the first substrate 3a.

As a material for the second substrate 3b, it is possible to use the same material as the first substrate 3a and may preferably be colorless and transparent. A material for the adhesive 3j may be the same as the adhesive 1j described above.

Next, another embodiment of the electrophoretic display of the present invention will be described.

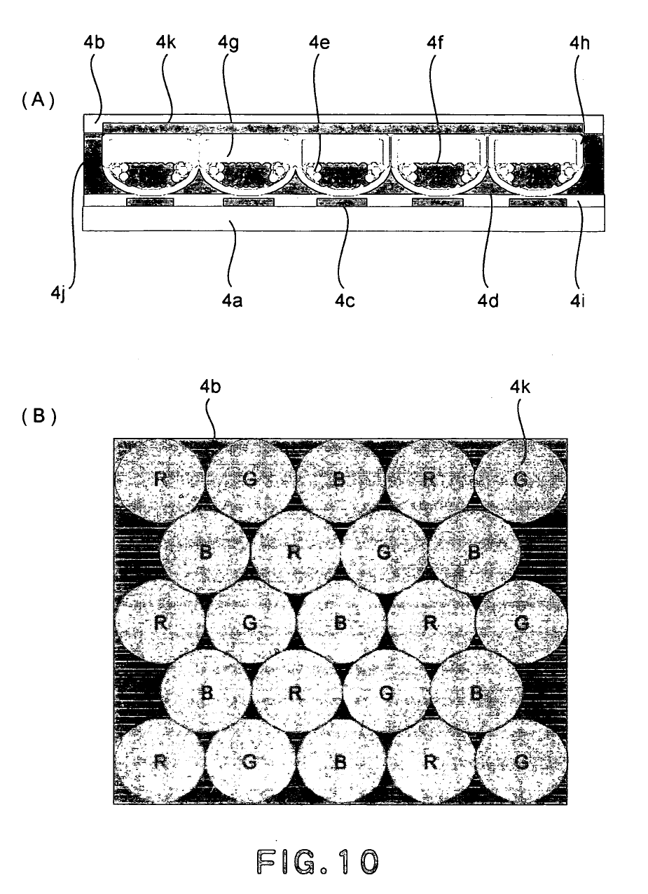

FIG. 10(A) is a sectional view showing a structure of another embodiment of the electrophoretic display of the present invention and FIG. 10(B) is a top view thereof.

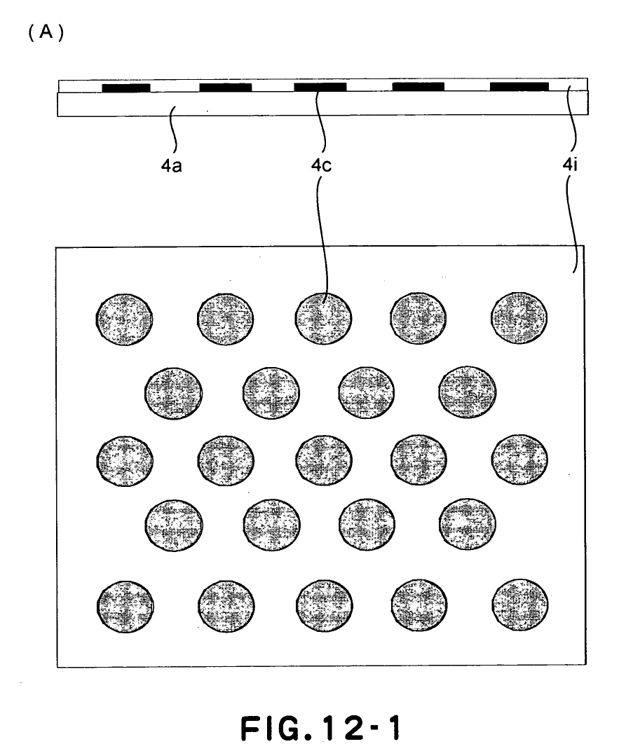

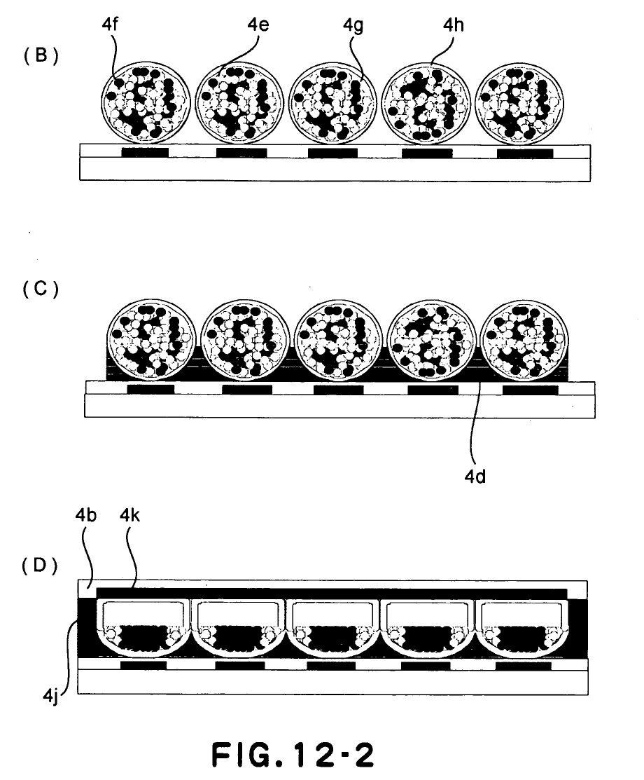

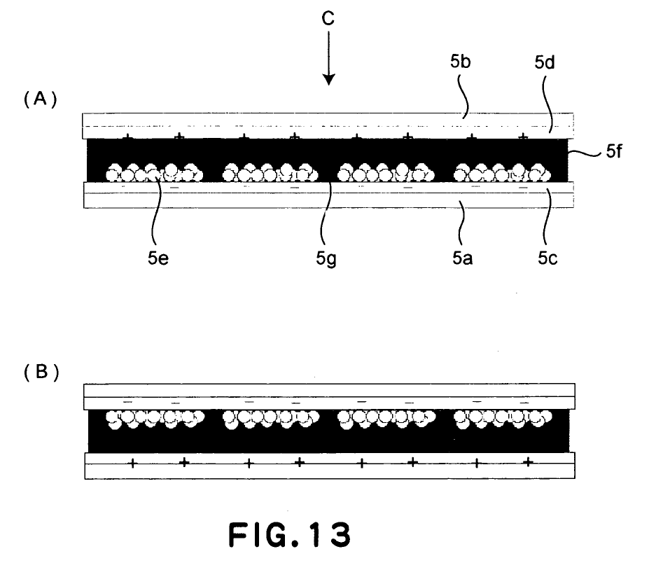

Referring to FIG. 10(A), the electrophoretic display includes a pair of first and second substrates 4a and 4b. On the first substrate 4a, a first electrode 4c and an insulating layer 4i are formed. On the first electrode 4c, a microcapsule 4h is disposed so as to be sandwiched between the first and second substrate 4a and 4b. The first and second substrates 4a and 4b are sealed with an adhesive 4j. At a spacing between the insulating layer 4i and the microcapsule 4h, a second electrode 4d is formed. The first electrode 4c has a circular shape having a predetermined size, and a plurality of circular first electrodes 4c are arranged in a honeycomb shape as shown in FIG. 12(A). Each of a plurality of microcapsules 4h has a shape such that a horizontal length thereof is longer than a vertical length thereof with respect to the first substrate 4a. Each microcapsule 4h contains a dispersion liquid comprising a dispersion medium 4g and two species of electrophoretic particles 4e and 4f different in color and polarity. The electrophoretic display has a display surface on the second substrate 4b side. Color filters 3k are two-dimensionally arranged as shown in FIG. 10(B) and disposed on associated first electrodes 4d so as to be one-to-one correspondence with the microcapsules 4h, respectively.

In FIG. 10, the first electrodes 4c are pixel electrodes each capable of independently applying a desired electric field to an associated microcapsule 4h. Each pixel electrode is provided with a switching device. To the pixel electrodes, a selection signal is applied from an unshown matrix drive circuit for each row line. Further, to the pixel electrodes, a control signal and an output from a drive transistor are applied. As a result, it becomes possible to apply a desired electric field to individual microcapsules 4h, respectively.

The two species of electrophoretic particles 4e and 4f in each microcapsule 4h are controlled by the electric field applied to the first electrode 4c, whereby white/black display is effected at each pixel. The second electrode 4d is a common electrode for applying a voltage at an identical potential over the entire display area.

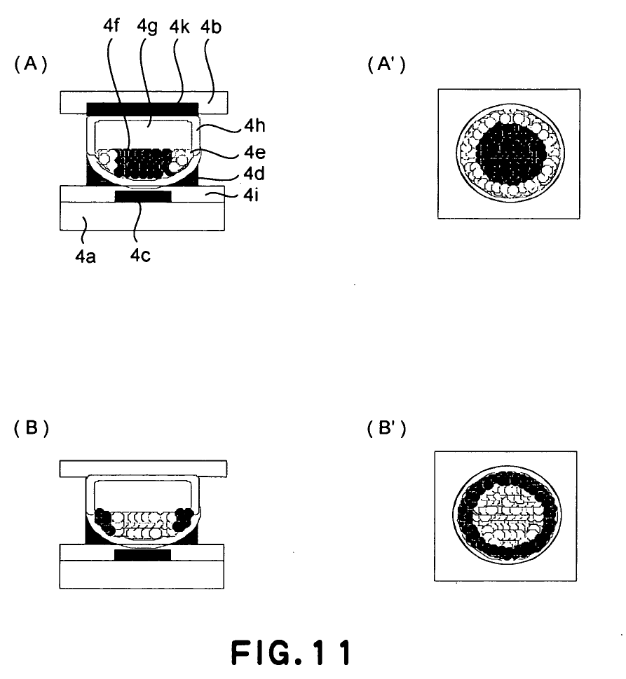

Next, a display operation of the electrophoretic display of the present invention will be described with reference to FIG. 11, wherein FIGS. 11(A) and 11(B) are sectional views of the electrophoretic display and FIGS. 11(A′) and 11(B′) are top views wherein the second substrate 4b provided with the color filters 4k is omitted.

As described above, each microcapsule 4h contains therein the electrophoretic particles 4e and 4f different in color and polarity and the dispersion medium 4g. The electrophoretic particles 4e are positively charged white particles, and the electrophoretic particles 4f are negatively charged black particles. The dispersion medium 4g an insulating solvent which is colorless and transparent. In these figures, the color filter 4k is red (R).

When 0 V is applied to the second electrode 4d and a positive (+) voltage is applied to the first electrode 4c, the electrophoretic particles 4e gather on the second electrode 4d and the electrophoretic particles 4f gather on the first electrode 4c. As a result, when the electrophoretic display is viewed from above, the microcapsules 4h look black (FIGS. 11(A) and 11(A′)). On the other hand, when 0 V is applied to the second electrode 4d and a negative (−) voltage is applied to the first electrode 4c, the electrophoretic particles 4e gather on the first electrode 4c and the electrophoretic particles 4f gather on the second electrode 4d. As a result, when the electrophoretic display is viewed from above, the microcapsules 4h look white (FIGS. 11(B) and 11(B′)).

In the case where the color filters 4k are green (G) or blue (B), it is possible to effect two-valued display of black/green or black/blue, respectively. Further, in the case where the color filters 4k are arranged on the second substrate 3b as shown in FIG. 10(B), it is possible to effect color display on the basis of electrophoresis of the electrophoretic particles 4e and 4f. In this embodiment, the color filters 4k employs primary colors of R, G and B but may also employ primary colors of yellow (Y), magenta (M), and cyan (C). Next, a production process of the electrophoretic display of the present invention will be described with reference to FIG. 12-1 and 12-2, wherein FIGS. 12-1(A), 12-2(B), 12-2(C) and 12-2(D) are process views showing a process for producing the electrophoretic display.

Referring to FIG. 12-1(A), on the first substrate 4a, a plurality of first electrodes 4c for controlling the dispersion liquid are patterned in a honeycomb shape consisting of circles each having a predetermined diameter, and thereon, the insulating layer 4i is formed.

The first substrate 4a is an arbitrary insulating member for supporting the electrophoretic display and is formed of glass, plastics, etc.

Patterning of the first electrodes 4c is performed through a photolithographic process with, e.g., Al or ITO. The circular first electrode 4c has a diameter which is 50-95%, preferably 60-90%, of that of the associated microcapsule 4h. If the diameter of the first electrode 4c is less than 50% or above 95% of the microcapsule 4h diameter, a resultant display contrast is undesirably lowered.

The insulating layer 4i may be polyimide as described.

On the first electrodes 4c disposed on the first substrate 4a, a plurality of microcapsules 4h each containing the dispersion liquid comprising the electrophoretic particles 4e and 4f and the dispersion medium 4g are disposed (FIG. 12-2(B)).

A method of arranging the microcapsules 4h is not particularly limited but may preferably be an ink jet method using nozzles or an electrostatic transfer method.

The microcapsules 4h may be prepared by the above described known method such as interfacial polymerization, in situ polymerization or coacervation method. The diameter of the microcapsules 4h may be 10-50 μm, preferably 20-200 μm.

If the diameter of the microcapsules 4h is smaller than 10 μm, a resultant display contrast is undesirably lowered. On the other hand, if the diameter is larger than 500 μm, a film strength of microcapsule 4h is lowered, thus being not practical. A material for forming the microcapsules 4h is the same as the microcapsules 1h described above.

Similarly, materials of the electrophoretic particles 4e and 4f and the dispersion medium 4g are the same as the electrophoretic particles 1e and 1f and the dispersion medium 1g, respectively.

To the dispersion liquid 4g, it is possible to add a charge control agent, a dispersing agent, a lubricant, a stabilizing agent, etc., as desired.

After the microcapsules 4h containing the dispersion liquid comprising the electrophoretic particles 4e and 4f and the dispersion medium 4g is arranged on the first electrodes 4c, the second electrode 4d is formed at a spacing between the insulating layer 4i and the microcapsules 4h (FIG. 12-2(C)).

The second electrode 4d may, e.g., be formed by infiltrating a solution of an electroconductive polymer dissolved in a solvent into the spacing between the insulating layer 2i and the microcapsules 4h, and then drying and removing the solvent. Examples of the electroconductive polymer and the solvent therefor may be the same as those described above.

After the second electrode 4d is formed at the spacing between the insulating layer 4i and the microcapsules 4h, the second substrate 4b is bonded to the first substrate 4a with an adhesive 4j so as to cover and seal the microcapsules 4h (FIG. 12-2(D)).

In the case of sealing the first and second substrates 4a and 4b with the adhesive 4j, it is preferable that a one-to-one correspondence is created between the color filters 4k and the microcapsules 4h and that the substrates are sealed under pressure so that a horizontal length of each microcapsule 4h is longer than a vertical length thereof with respect to the first substrate 4a.

As a material for the second substrate 4b, it is possible to use the same material as the first substrate 4a. A material for the adhesive 4j is also the same as the adhesive 1j.

As described hereinabove, according to the present invention, by using the microcapsules each containing the dispersion liquid comprising the dispersion medium and two species of electrophoretic particles different in polarity and color, it becomes possible to suppress movement of electrophoretic particles to adjacent pixels and leakage of the dispersion liquid out of the electrophoretic display, which are problematic is the conventional electrophoretic display.

Hereinbelow, the present invention will be described more specifically based on Examples.

### EXAMPLE 1

An electrophoretic display as shown in FIG. 1 is prepared through a production process shown in FIG. 3.

On a first substrate 1a of PET film (300 μm thick), a first electrode 1c of Al layer (0.2 μm thick) is formed and thereon, an insulating layer 1i, a second electrode 1d of Al layer (0.1 μm thick) is formed and patterned in a honeycomb shape comprising circles (diameter: 40 μm) through a photolithographic process. The distance (pitch) between (centers of) adjacent electrodes is set to 60 μm.

A dispersion liquid is prepared by dispersing 9 wt. % of white electrophoretic particles 1e of titanium oxide (average particle size: 0.2 μm), 8 wt. % of black electrophoretic particles of carbon black coated with styrene-divinylbenzene resin (average particle size: 0.5 μm), and 0.5 wt. % of a charge control agent (trade name: “OLOA”, mfd. by Chevron Corp.) in 1g of dispersion medium 1g (trade name: “Isopar H”, mfd. by Exxon Corp.).

Microcapsules 1h each containing the above prepared dispersion liquid are prepared through in situ polymerization method and subjected to classifying operation to obtain microcapsules 1h each having a particle (capsule) size of 55-60 μm. A film material for the microcapsules 1h is urea-formaldehyde resin.

Then, by using an ink jet method with nozzles, the above prepared microcapsules 1h are arranged on the second electrode 1d. In this case, in order to prevent positional deviation of the microcapsules 1h to be disposed on the substrate, a light-transmissive resin binder of polyvinyl alcohol is filled in the spacing between the microcapsules 1h, thus fixing the microcapsules 1h on the substrate.

The upper surface of the microcapsules 1h is covered with a second substrate 1b of colorless and transparent PET film (100 μm thick) and sealed under pressure with an adhesive 1j of polyester resin so that a horizontal length of microcapsule 1h is longer than a vertical length of microcapsule with respect to the first substrate 1a. To the first and second electrodes 1c and 1d, a voltage application circuit is connected, thereby to obtain an electrophoretic display according to the present invention.

When the electrophoretic display is driven by applying a voltage of ±15 V between the first and second substrates, it is possible to effect high-definition white/black display as shown in FIG. 2 based on horizontal movement of two species of the electrophoretic particles 1e and 1f at each pixel, thus preventing movement of the electrophoretic particles to adjacent pixels and leakage of the dispersion liquid out of the electrophoretic display.

### EXAMPLE 2

An electrophoretic display as shown in FIG. 4 is prepared through a production process shown in FIG. 6.

On a first substrate 2a of quartz glass (500 μm thick), a first electrode 2c of Al layer (0.1 μm thick) is formed and patterned in a honeycomb shape comprising circles (diameter: 40 μm) through a photolithographic process. The distance (pitch) between (centers of) adjacent electrodes is set to 60 μm. On the first electrode 2c and the first electrode 2a, an insulating layer 2i of polyimide resin layer (3 μm thick) is formed.

Then, by using an ink jet method with nozzles, microcapsules 2h prepared in the same manner as in Example 1 are arranged on the first electrode 2c.

At a spacing between the microcapsules 2h and the insulating layer 2i, a chloroform solution of polypyrrole represented by the following formula (I): 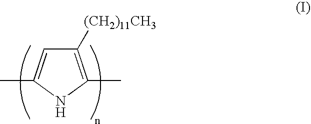
is infiltrated, followed by removal of chloroform to form a second electrode 2d.

The upper surface of the microcapsules 2h is covered with a second substrate 2b of colorless and transparent PET film (100 μm thick) and sealed under pressure with an adhesive 2j of epoxy resin so that a horizontal length of microcapsule 2h is longer than a vertical length of microcapsule with respect to the first substrate 2a. To the first and second electrodes 2c and 2d, a voltage application circuit is connected, thereby to obtain an electrophoretic display according to the present invention.

When the electrophoretic display is driven by applying a voltage of ±15 V between the first and second substrates, it is possible to effect high-definition white/black display as shown in FIG. 5 based on horizontal movement of two species of the electrophoretic particles 2e and 2f at each pixel, thus preventing movement of the electrophoretic particles to adjacent pixels and leakage of the dispersion liquid out of the electrophoretic display.

### EXAMPLE 3

An electrophoretic display as shown in FIG. 7 is prepared through a production process shown in FIG. 9.

On a first substrate 3a, a first electrode 3c, an insulating layer 3i and a second electrode 3d are formed in the same manner as in Example 1.

Then, by using an ink jet method with nozzles, microcapsules 3h prepared in the same manner as in Example 1 are arranged on the second electrode 3d. In this case, in order to prevent positional deviation of the microcapsules 3h to be disposed on the substrate, a light-transmissive resin binder of polyurethane is filled in the spacing between the microcapsules 3h, thus fixing the microcapsules 3h on the substrate.

The upper surface of the microcapsules 1h is covered with a second substrate 1b of PET film (100 μm thick) provided with patterned color filters 3k of R, G and B and is sealed under pressure with an adhesive 3j of polyester resin so that the color filters 3k creates one-to-one correspondence with the microcapsules 3h and that a horizontal length of microcapsule 3h is longer than a vertical length of microcapsule with respect to the first substrate 3a. To the first and second electrodes 3c and 3d, a voltage application circuit is connected, thereby to obtain an electrophoretic display according to the present invention.

When the electrophoretic display is driven by applying a voltage of ±15 V between the first and second substrates, it is possible to effect high-definition color display as shown in FIG. 8 based on horizontal movement of two species of the electrophoretic particles 3e and 3f at each pixel, thus preventing movement of the electrophoretic particles to adjacent pixels and leakage of the dispersion liquid out of the electrophoretic display.

### EXAMPLE 4

An electrophoretic display as shown in FIG. 10 is prepared through a production process shown in FIG. 12.

On a first substrate 4a, in the same manner as in Example 2, a first electrode 4a and an insulating layer 4i are formed.

Then, by using an ink jet method with nozzles, microcapsules 4h prepared in the same manner as in Example 1 are arranged on the first electrode 4c.

At a spacing between the microcapsules 4h and the insulating layer 4i, a chloroform solution of polythiophene represented by the following formula (II): 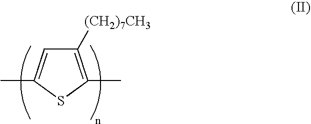
is infiltrated, followed by removal of chloroform to form a second electrode 4d.

The upper surface of the microcapsules 4h is covered with a second substrate 4b of colorless and transparent PET film (100 μm thick) provided with patterned color filters 4k of R, G and B and is sealed under pressure with an adhesive 4j of epoxy resin so that the color filters 4k creates one-to-one correspondence with the microcapsules 4h and that a horizontal length of microcapsule 4h is longer than a vertical length of microcapsule with respect to the first substrate 4a. To the first and second electrodes 4c and 4d, a voltage application circuit is connected, thereby to obtain an electrophoretic display according to the present invention.

When the electrophoretic display is driven by applying a voltage of ±15 V between the first and second substrates, it is possible to effect high-definition color display as shown in FIG. 11 based on horizontal movement of two species of the electrophoretic particles 4e and 4f at each pixel, thus preventing movement of the electrophoretic particles to adjacent pixels and leakage of the dispersion liquid out of the electrophoretic display.

1. An electrophoretic display, comprising: a substrate, a first electrode and a second electrode disposed on said substrate, and microcapsules each, disposed on said substrate, containing a dispersion liquid comprising a dispersion medium and two species of electrophoretic particles different in charge polarity and color,
wherein said first and second electrodes are disposed so as to create an electric field along a surface of said substrate and are to be supplied with a voltage so as to move said two species of electrophoretic particles in mutually opposite directions along said electric field to effect display.

2. A display according to claim 1, wherein both of said first and second electrodes are disposed on the surface of said substrate.

3. A display according to claim 1, wherein said first electrode is disposed on the surface of said substrate and said second electrode is disposed between adjacent microcapsules.

4. A display according to claim 2, wherein the colors of said two species of electrophoretic particles are white and black and said display effects white and black display.

5. A display according to claim 1, wherein a color filter is disposed on said microcapsules to effect color display.
